(19) United States
(12) Patent Application Publication
(10) Pub. No.: US 2021/0366323 A1
(43) Pub. Date: Nov. 25, 2021

(54) Wheel Chock Retainer

(71) Applicant: Robert Buell, Des Moines, IA (US)

(72) Inventor: Robert Buell, Des Moines, IA (US)

(21) Appl. No.: 17/315,507

(22) Filed: May 10, 2021

Related U.S. Application Data
(60) Provisional application No. 63/026,753, filed on May 19, 2020.

(51) Int. Cl. G09F 21/04

(52) U.S. Cl. CPC G09F 21/049; B60T 3/00

(57) ABSTRACT

This present invention relates to a missing wheel chock alert device that features a flag or indicator system on one side of the device that is easily visible to a vehicle operator through the side view mirror. The wheel chock alert device provides notification to an operator regarding a missing, lost, or unsecured wheel chock; and therefore, ensures that the vehicle operator does not leave the wheel chock(s) at jobsites and other areas. Additionally, the wheel chock alert device offers ease and convenience when identifying the position and status of the wheel chock, and ensures the wheel chock remains secure.

### CROSS-REFERENCE TO RELATED APPLICATION

The present application claims priority to, and the benefit of, U.S. Provisional Application No. 63/026,753, which was filed on May 19, 2020 and is incorporated herein by reference in its entirety.

### FIELD OF THE INVENTION

The present invention relates generally to the field of wheel chock systems. More specifically, the present invention relates to a wheel chock alert device that provides operators with a notification system for missing wheel chocks, thereby ensuring the chock is replaced, or returned to a stored position, before operating the vehicle. The wheel chock alert device features a visual indicator on one side of the device. The visual indicator is easily seen when the operator looks through a side view mirror (i.e. driver's side view mirror). The wheel chock alert device notifies an operator if a wheel chock is missing or is in use, and ensures the wheel chock is not left behind, lost and/or damaged. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, use of wheel chock systems have been known in the state of the art. Wheel chocks (or chocks) are wedges of sturdy material such as polyurethane or rubber, that are placed closely against a vehicle's wheels to prevent accidental or incidental movement. The chocks can be placed in front of and/or behind tires to prevent unwanted movement of a vehicle. Chocks are typically used in conjunction with a vehicle braking system to secure the vehicle in a stationary position. For safety reasons, a vehicle prohibited from inadvertent movement provides a much safer environment to individuals working and walking adjacent to the vehicle. Wheel chocks are considered to be an effective safety device for vehicles if the chock devices are used properly.

When a vehicle is in an idle or parked condition and an operator desires to secure the vehicle in a stationary position, a wheel chock device is typically used for placement against one or more of the vehicle's wheel(s). A wheel chock can then be taken out from a storage area of the vehicle and positioned properly against the vehicle's wheel(s) to prevent any unwanted movement of the vehicle. Once the vehicle is ready for use again, the wheel chock device placed against the vehicle's wheel needs to be removed and placed into the storage area. However, operators or drivers often forget to remove the wheel chock that was previously placed against the vehicle's wheel. In situations where the wheel chock is placed in front or behind one or more of the vehicle's wheels and the operator forgets to remove the wheel chock, the result is inconvenience in further operating the vehicle and damages to the wheel chock as well. In case the wheel chock is placed behind the vehicle's rear wheel, and the operator forgets to remove the wheel chock, there is a potential of forgetting the wheel chock and leaving it behind at the jobsites and other areas. Replacing and purchasing wheel chocks can be costly and frustrating for operators and vehicle owners. Further, in situations where wheel chocks are not securely fastened to a vehicle, unsecured chocks can fly out onto the road when the vehicle is in motion. The resultant obstruction on the road presents a hazard for other motorists.

Currently, there are no means for vehicle drivers or operators to be alerted to the fact that the wheel chock is missing, still in use or unsecured before operating the vehicle. Operators may have to manually check the presence of the wheel chock in a vehicle's storage area prior to operating the vehicle. This manual activity is a time consuming and frustrating task for the operators.

Therefore, there exists a long felt need in the art for a wheel chock alert device that notifies operators of missing wheel chocks. There is also a long felt need in the art for a wheel chock alert device that eliminates the need to continuously manually check the presence of a wheel chock in a vehicle's storage area each time before operating the vehicle. Additionally, there is a long felt need in the art for a wheel chock alert device that ensures the wheel chock is returned to a storage position within the vehicle before operation resumes. Moreover, there is a long felt need in the art for a wheel chock alert device that prevents the wheel chock system from being damaged or lost in case the operator forgets to replace the wheel chock. Further, there is a long felt need in the art for a wheel chock alert device that prevents the wheel chock from being left behind or lost at jobsites and other locations. Furthermore, there is a long felt need in the art for a wheel chock alert device that prevents motorists and other vehicle operators from facing hazards due to unsecured wheel chocks landing onto the road or being left behind in parking lots. Finally, there is a long felt need in the art for a wheel chock alert device that provides a convenient missing wheel chock alert system, thereby preventing drivers from losing and/or leaving wheel chocks behind at jobsites and other locations.

The subject matter disclosed and claimed herein, in one embodiment thereof, comprises a missing wheel chock alert device to notify an operator of a vehicle in the event that the wheel chock is missing from its storage position. The missing wheel chock alert device comprises: a retainer, bracket or docking unit dimensioned as per a wheel chock, an extension arm connecting and extending from the device, and a flag attached to the extension arm wherein the missing wheel chock alert device enables the flag to extend outward from the bracket so as to be visible to the operator via a side view mirror, indicating absence of the wheel chock. The missing wheel chock alert device, when the wheel chock has been returned to the bracket, causes the extension arm to be pushed back into the bracket such that the flag is not visible to the operator via the side view mirror, indicating secure placement of the wheel chock in the bracket.

In this manner, the novel wheel chock alert device of the present invention accomplishes all of the forgoing objectives, and provides a relatively easy, convenient and effective solution to provide notification to operators regarding missing wheel chocks, thereby ensuring the wheel chocks are not left behind at jobsites and other locations, and are returned before operating the vehicle. The wheel chock alert device of the present invention is also user friendly, as it eliminates the need to manually check if the wheel chock has been returned and stowed in the vehicle's storage area. The wheel chock alert device ensures the safety of wheel chocks and prevents unnecessary expense and hassles due to the inadvertent abandonment of wheel chocks.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a wheel chock alert device to notify an operator of a vehicle about a missing, misplaced or in use wheel chock. The wheel chock alert device comprises: a retainer, bracket or docking unit dimensioned as per a wheel chock; an extension arm connecting and extending from the device including a flag attached to the extension arm; the flag is deployed when the wheel chock is missing from the wheel chock retainer; and, wherein the deployed flag is visible to the operator via a side view mirror when the wheel chock is missing from the wheel chock retainer. When the wheel chock has been returned to the wheel chock retainer or bracket, the wheel chock extension arm is pushed back into the retainer or bracket once the wheel chock has been inserted into the bracket, such that the flag is unviewable to the operator via the side view mirror, indicating the secure placement of the wheel chock into the wheel chock bracket.

In a further embodiment of the present invention, a portable and lightweight flag device that is capable of alerting an operator of a missing wheel chock is disclosed and comprises: a solid retainer body having tapered sides forming a V-shape; one or more flags extending from the sides of the solid retainer body, wherein the flag device is configured to be inserted in a mounted bracket attached to a vehicle; the extended flag(s) can be visible to the operator via a side view mirror indicating the absence of the wheel chock in the bracket; and the retractable flag(s) being unviewable to the operator via the side view mirror, indicating the presence of the wheel chock in the retainer or bracket. The wheel chock device, when the wheel chock is inserted into the bracket, provides for retraction of the flag device, thereby moving the flags out of the view of the operator. It is to be appreciated that the operator can make a determination as to the status of the wheel chock while seated in the driver's seat of the vehicle

The missing wheel chock alert device of the present invention prevents operators from losing, misplacing or leaving behind wheel chocks at jobsites and other areas. The device further offers ease and convenience when identifying the location of a wheel chock and ensures that a wheel chock is never left behind and/or lost. The extended flag can be easily viewed by the operator looking in the driver's side view mirror of a vehicle when the wheel chock is missing from the wheel chock retainer. The device, discussed herein, eliminates the unsafe practice of retaining wheel chocks to a vehicle with the use of chains. The device of the present invention is portable, lightweight and sizeable, while providing an economical and simple method to prevent the loss of wheel chocks.

The flag device of the present invention can be commercially available with a wheel chock along with the optional mounted retainer or bracket. It is to be appreciated that the flags can come in multiple sizes, colors, and quantities to meet the requirements of operators based on the size of the vehicle and placement of the bracket thereto.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a wheel chock alert device of the present invention in accordance with the disclosed architecture;

FIG. 2A illustrates a perspective view of one potential embodiment of the wheel chock alert device of the present invention mounted to the side of a vehicle in accordance with the disclosed architecture;

FIG. 2B illustrates a perspective view of another potential embodiment of a wheel chock alert device of the present invention in accordance with the disclosed architecture;

FIG. 3 illustrates a perspective view of one potential embodiment illustrating how the wheel chock alert device of the present invention can provide a visible alert in a side view mirror of a vehicle, thereby indicating a missing wheel chock in accordance with the disclosed architecture;

FIG. 4 illustrates a perspective view of one potential embodiment showing a wheel chock being inserted into a mounted bracket of the wheel chock device to actuate the alert device of the present invention in accordance with the disclosed architecture; and

FIG. 5 illustrates a perspective view of one potential embodiment showing a wheel chock inserted into a mounted bracket of the wheel chock device with the alert device in the retracted position in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a wheel chock alert device that notifies operators of missing wheel chocks. There is also a long felt need in the art for a wheel chock alert device that eliminates the need to check the presence of wheel chocks in a vehicle's storage area before operating the vehicle. Additionally, there is a long felt need in the art for a wheel chock alert device that ensures the wheel chock is returned to a secured position before operating the vehicle. Moreover, there is a long felt need in the art for a wheel chock alert device that prevents a wheel chock from being damaged or lost in case the operator forgets the wheel chock. Further, there is a long felt need in the art for a wheel chock alert device that prevents the wheel chock from being misplaced, lost or left behind at jobsites and other locations. Furthermore, there is a long felt need in the art for a wheel chock alert device that prevents motorists and other vehicle operators from facing a hazard due to unrestrained or improperly secured wheel chocks inadvertently being flung onto the roadway. Finally, there is a long felt need in the art for a wheel chock alert device that provides a convenient method to alert an operator to a missing wheel chock, thereby preventing operators from leaving wheel chocks at jobsites and other areas

The present invention, in one exemplary embodiment, is a novel wheel chock alert device that provides notification to an operator of a vehicle regarding the status of wheel chocks. The wheel chock alert device comprises: a retainer, bracket or docking unit dimensioned as per a wheel chock; an extension arm extendable and retractable from the device; and a flag attached to the extension arm, wherein the flag is actuated when the wheel chock is removed from the mounted bracket of the wheel chock device; the flag, extending outward from the bracket, is viewable to the operator via the driver's side view mirror indicating absence of a wheel chock; and the extension arm of the wheel chock alert device is retractable when the wheel chock is returned to the bracket, such that the flag is unviewable to the operator via the driver's side view mirror indicating the secure placement of the wheel chock in the bracket.

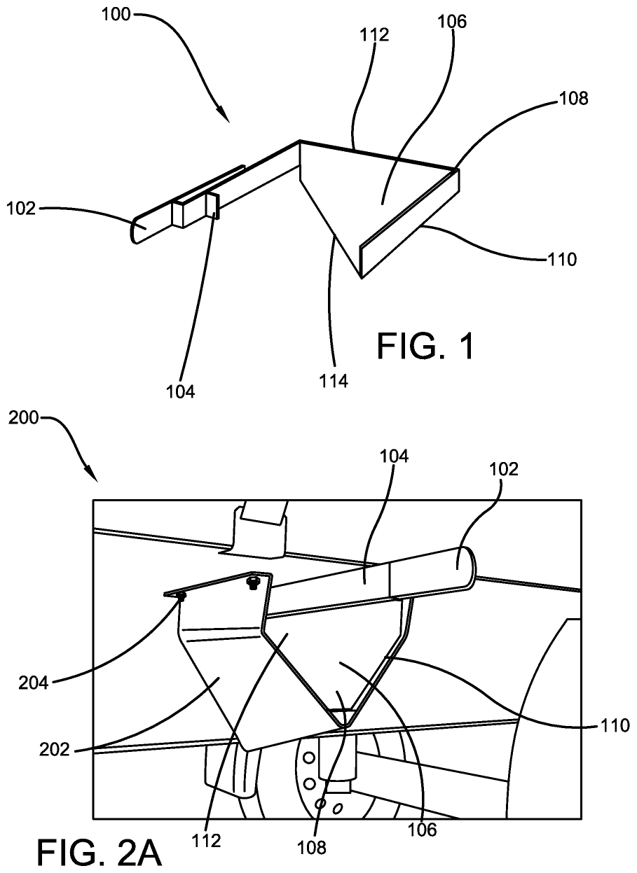

Referring initially to the drawings, FIG. 1 illustrates a perspective view of one potential embodiment of a wheel chock alert device 100 of the present invention in accordance with the disclosed architecture. The missing wheel chock alert device 100 can be configured and dimensioned to correspond to the shape and dimensions of typical wheel chocks. The alert device 100 can be easily mounted to a vehicle to enable convenient access to the wheel chocks retained therein. A red flag or other visible indicator 102 is outwardly extendable from the alert device 100. It is to be appreciated that the flag 102 extends and retracts in accordance with movements of an extension arm 104 of the alert device 100. The red flag 102, attached or affixed to the extension arm 104, can be projected outwards away from the side of a vehicle, such that the attached red flag 102 is clearly visible to an operator of the vehicle from at least a side view mirror 302 (FIG. 3). By viewing the red flag 102, the operator becomes aware of the absence of a wheel chock in the bracket mounted on the vehicle, and is therefore on notice that the wheel chock has not been returned to the alert device 100.

As discussed above, the wheel chock alert device 100 can be shaped and dimensioned according to conventional wheel chock sizes and can include a bracket 101 comprising a frame 106 having a first tapered side 112 to which the extension arm 104 is attached. A second tapered side 110 connects to the first tapered side 112 along a bottom edge 108. A top edge 114 of the wheel chock alert device 100 forms the top side of the frame 106. The first tapered side 112 and the second tapered side 110 are similar in size and orientation. The wheel chock alert device 100 includes a relatively thin construction, providing for a compact and lightweight device made up of a sturdy material such as metal, rubber, HDPE (high density polyethylene) or other durable and impact resistant materials.

The frame 106 of the wheel chock alert device 100 can comprise a unitary construction. The wheel chock alert device 100 of the present invention can be constructed in any number of dimensions and sizes to fit and use with different types of wheel chocks. The extension arm 104 and the red flag 102 attached thereto, and articulated therewith, allow an operator to see the flag 102 from a distance. In one illustrative embodiment, the extension arm 104 can actuate a lateral distance, generally from about 6 inches to about 18 inches in length, from a retracted position to an extended position and vice versa. The wheel chock alert device 100 can come in multiple colors to match with the color of the vehicle.

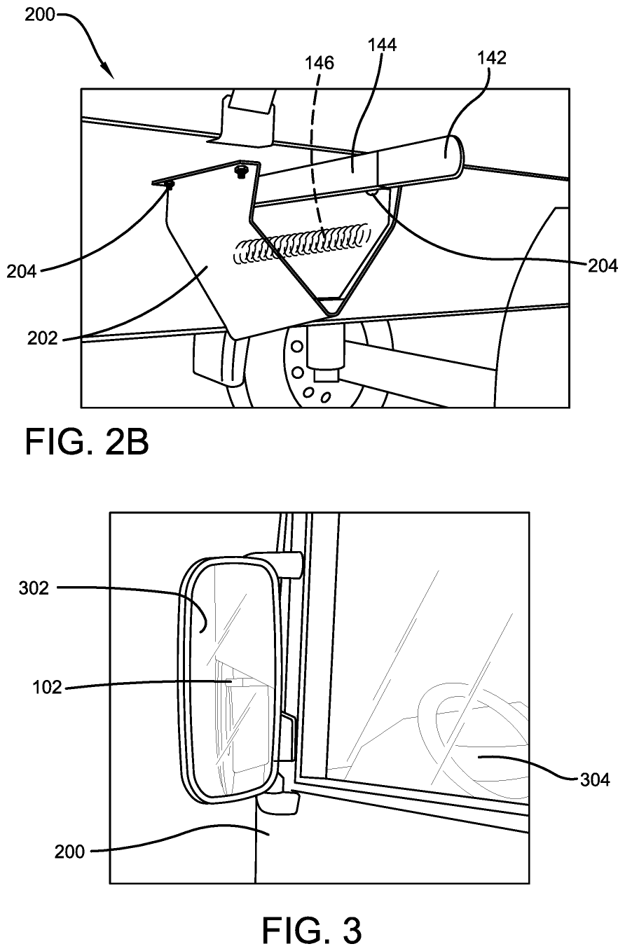

FIG. 2A illustrates a perspective view of one potential embodiment of the wheel chock alert device 100 of the present invention. As shown, the wheel alert device 100 is mounted to a side (i.e. driver's side) of a vehicle 200 in accordance with the disclosed architecture. A mounting bracket 202 can be secured to a vehicle 200 using nuts and bolts 204. The bracket 202 can be included with other components of the wheel chock alert device 100 and sold as a kit, or the chock alert device 100 can be purchased and mounted separately. The wheel chock alert device 100 can be inserted into the bracket 202 such that the alert device 100 fits completely within the internal cavity of the bracket 202. The extension arm 104 and the indicator or flag 102 can extend outward away from the bracket 202, thereby creating a lateral distance from the side of the vehicle 200.

When the missing wheel chock alert device 100 is inserted into the bracket 202, the tapered sides 112, 110 are placed along the corresponding tapered sides of the bracket 202. The bottom edge 108 of the alert device 100 abuts the bottom of the bracket 202. Due to the thin construction of the sides or walls 110, 112 of the alert device 100, the alert device 100 can be easily moved within the bracket 202 in a direction towards or away from the vehicle. In the scenario where only the alert device 100 is placed within the bracket 202, without any wheel chocks retained therein, the extension arm 104 remains extended outwardly away from the vehicle, thereby placing flag 102 in a viewable position relative to the driver's side view mirror 302 (FIG. 3).

Another alternative embodiment of a wheel chock device or retainer 140 is shown in FIG. 2B. An extension arm 144 and an indicator 142 can be actuated with a spring 146 attached to the bracket 202. In this embodiment, when the wheel chock 400 is removed from the wheel chock retainer 140, the spring 146 automatically actuates the extension arm 144 outwardly from the side of the vehicle 200. The extension remains biased outward until the spring force is overcome by pushing a wheel chock 400 and the wheel chock retainer 140 back into bracket 202.

FIG. 3 illustrates a perspective view of one potential embodiment showing how the wheel chock alert device 100 of the present invention is viewable in a side view mirror of a vehicle. As illustrated, the device 100 is void of wheel chocks 400. When the chock device 100 is void of wheel chocks 400, the extension arm 104 is not restrained and is therefore able to extend outwardly from the vehicle 200. The flag 102 then correspondingly extends outwardly from the alert device 100. The flag 102, when outwardly extended, becomes easily viewable to a driver via the side view mirror 302. The driver, while sitting in the driver's seat 304, can easily view the red flag 102 and become aware that the wheel chock(s) is not present in the bracket. The visible flag 102 provides notice to an operator that the wheel chock needs to be returned or inserted within the bracket 202. It should be appreciated that the color of the flag can be of any color and can be chosen based on the visibility of the color. Depending on the location of the bracket 202 on the vehicle 200, the length of the extension arm 104 to which the flag 102 is attached can have a telescoping mechanism to increase the length of the arm.

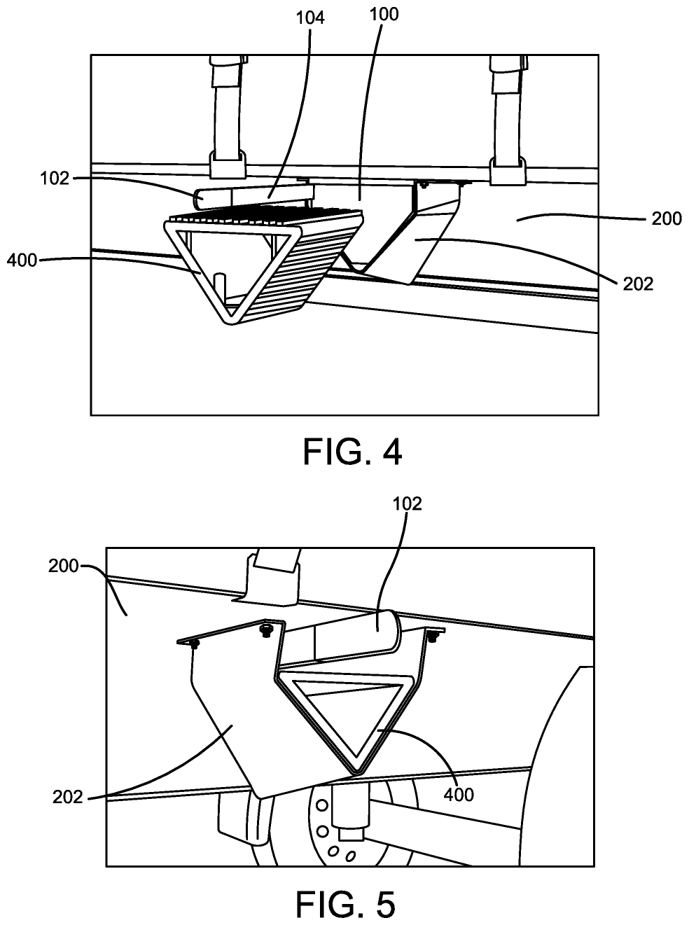

FIG. 4 illustrates a perspective view of one potential embodiment showing a wheel chock 400 inserted into the mounting bracket 202 to push backwards the alert device of the present invention into the bracket in accordance with the disclosed architecture. To place and secure a wheel chock device 100 into the bracket 202, the wheel chock 400 pushes the alert device 100 back into the bracket 202 towards the vehicle 200 and thus, in turn, pushes or retracts the flag 102 backwards. The flag 102, in the retracted orientation, is no longer visible (i.e. unviewable) from the side view mirror 302 while an operator is sitting in a driver's seat. When the flag 102 is unviewable, the operator knows that the wheel chock 400 is securely placed in the bracket 202. The above described device and method ensures that a wheel chock 400 is never left behind and/or lost. The operator merely needs to look into the side view mirror to ascertain whether the wheel chock 400 has been placed in the bracket 202. It should be noted that in one commercially viable option of the present invention, one or more wheel chocks 400, a mounting bracket 202 and a wheel chock alert device 100 can be made available as a kit.

FIG. 5 illustrates the wheel chock device inserted into the bracket 202 with the flag 102 completely pushed back, i.e. in the fully retracted orientation, such that the flag 102 is out of view from the operator in accordance with the disclosed architecture. When the wheel chock 400 is inserted into the bracket 202, the alert device 100 is pushed back towards the vehicle 200, such that the alert device 100 can touch the rear surface of the bracket 202, thus, pushing back the extension arm 104 inwards and towards the side of the vehicle 200. The flag 102, when unviewable to an operator from the side view mirror, alerts the operator that the wheel chock 400 and wheel chock device 100 are inserted and securely placed in the bracket 202. The flag device 100 prevents operators from losing and/or leaving wheel chocks at jobsites and other locations. The operator does not have to come near to the bracket to ascertain whether the chock device 400 is securely placed onto the vehicle.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “missing wheel chock alert device”, “alert device”, “chock alert device”, “flag device” and “wheel chock alert device” are interchangeable and refer to the missing wheel chock alert device 100 of the present invention.

Notwithstanding the forgoing, the missing wheel chock alert device 100 of the present invention can be of any suitable size and configuration as is known in the art without affecting the overall concept of the invention, provided that it accomplishes the above-stated objectives. One of ordinary skill in the art will appreciate that the size, configuration and material of the missing wheel chock alert device 100 as shown in the FIGS. are for illustrative purposes only, and that many other sizes and shapes of the missing wheel chock alert device 100 are well within the scope of the present disclosure. Although the dimensions of the missing wheel chock alert device 100 are important design parameters for operator convenience, the missing wheel chock alert device 100 can be of any size that ensures optimal performance during use and/or that suits the operator's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wheel chock storage device configured to provide a status for a vehicle operator, the wheel chock storage device comprising:
a mounting bracket for attachment to a vehicle, wherein said mounting bracket comprises an alert device;
said alert device comprising an extension arm and a visible indicator;
said alert device is movable from a retracted position to an extended position when a wheel chock is being removed from said wheel chock storage device; and
said indicator is viewable to the vehicle operator in said extended position, and said indicator is unviewable to the vehicle operator in said retracted position.

2. The wheel chock storage device of claim 1, wherein said alert device movable from a retracted position to an extended position is spring actuated.

3. The wheel chock storage device of claim 1, wherein said indicator viewable to the vehicle operator in said extended position, and said indicator unviewable to the vehicle operator in said retracted position is through a side view mirror of the vehicle.

4. The wheel chock storage device of claim 3, wherein said side view mirror is viewed by the vehicle operator while sitting in a driver's seat of the vehicle.

5. The wheel chock storage device of claim 4, wherein said indictor is affixed to an end of said extension arm.

6. The wheel chock storage device of claim 5, wherein said indicator is brightly colored.

7. The wheel chock storage device of claim 4, wherein said alert device is movable from an extended position to a retracted position when a wheel chock is being mounted in said wheel chock storage device.

8. A wheel chock storage device configured to provide a status for a vehicle operator, the wheel chock storage device comprising:
a mounting bracket for attachment to a vehicle, wherein said mounting bracket comprises an alert device and a mount for a wheel chock;
said alert device comprising an extension arm and a visible indicator;
said alert device is movable from a retracted position to an extended position when the wheel chock is being removed from said wheel chock storage device;
said movement of said alert device from said retracted position to said extended position comprises a lateral distance generally about 6 inches to about 18 inches; and
said indicator is viewable to the vehicle operator in said extended position, and said indicator is unviewable to the vehicle operator in said retracted position.

9. The wheel chock storage device of claim 8, wherein said alert device movable from a retracted position to an extended position is spring actuated.

10. The wheel chock storage device of claim 8, wherein said indicator viewable to the vehicle operator in said extended position, and said indicator unviewable to the vehicle operator in said retracted position is through a side view mirror of the vehicle.

11. The wheel chock storage device of claim 10, wherein said side view mirror is viewed by the vehicle operator while sitting in a driver's seat of the vehicle.

12. The wheel chock storage device of claim 11, wherein said indictor is affixed to an end of said extension arm.

13. The wheel chock storage device of claim 12, wherein said indicator is brightly colored.

14. The wheel chock storage device of claim 13, wherein said alert device is movable from an extended position to a retracted position when a wheel chock is being mounted in said storage device.

15. A method of using a wheel chock storage device configured to provide a status for a vehicle operator, the method comprising:
providing a mounting bracket for attachment to a vehicle, wherein said mounting bracket comprises an alert device and a mount for a wheel chock;
said alert device comprising an extension arm and an indicator;
removing the wheel chock from said mounting bracket;
moving said alert device from a retracted position to an extended position, wherein moving said alert device comprises a lateral distance generally from about 6 inches to about 18 inches;
said indicator unviewable when said alert device is in said retracted position;
said indicator is viewable when said alert device is in said extended position; and
viewing said indicator in said extended position, wherein said viewing is in a side view mirror by the vehicle operator.

16. The method of claim 15, wherein the vehicle operator is sitting in a driver's seat.

17. The method of claim 15, further comprising replacing the wheel chock into said mounting bracket.

18. The method of claim 17, further comprising moving said alert device from said extended position to said retracted position.

19. The method of claim 18, wherein said moving comprises overcoming a spring force of said alert device.

20. The method of claim 18, further comprising removing said indicator from said view of the operator.
